(19) United States
(12) Patent Application Publication
(10) Pub. No.: US 2026/0240720 A1
(43) Pub. Date: Aug. 20, 2026

(54) FACIAL TAPPING APPARATUS DRIVEN BY VOICE COIL MOTOR

(71) Applicant: Fasheng LIU, Shenzhen (CN)

(72) Inventor: Fasheng LIU, Shenzhen (CN)

(21) Appl. No.: 19/634,158

(22) Filed: Mar. 31, 2026

(30) Foreign Application Priority Data
Jan. 29, 2026 (CN) 202620124613.4

(51) Int. Cl. A61H 23/02

(52) U.S. Cl. CPC A61H 23/0218; A61H 2201/0111; A61H 2201/0153; A61H 2201/0207; A61H 2201/10; A61H 2201/123; A61H 2201/5058; A61H 2205/022

(57) ABSTRACT

A facial tapping apparatus driven by a voice coil motor, including: a housing, a tapping head and a voice coil motor. The tapping head is arranged at a front end of the housing. The voice coil motor is positioned within the housing and connected to the tapping head. And the voice coil motor is configured to drive the tapping head to reciprocate along a tapping direction relative to the housing. A front end of the tapping head comprises a skin care contact portion, the skin care contact portion being configured for contacting human skin.

### CROSS REFERENCE TO RELATED APPLICATIONS

This application claims priority to Chinese Patent Application No. 202620124613.4, filed on January 29, 2026 in the China National Intellectual Property Administration, the entail disclosure of which are hereby incorporated by reference.

### TECHNICAL FIELD

The present disclosure relates to the technical field of facial care devices, in particular to a facial tapping apparatus driven by a voice coil motor.

### BACKGROUND

With the development of beauty and skincare technologies, various types of facial massage devices have been widely used in the field of facial care, such as vibration massagers, roller massagers, and fascia guns. These devices generally implement massage stimulation on the skin through vibration, motor drive, or mechanical structures, promoting blood circulation and enhancing skin vitality.

However, existing facial massage devices still have certain shortcomings. For example, some devices utilize eccentric vibration motors or rotary motors to drive the massage head, wherein the vibration mode is relatively limited, and it is difficult to achieve a stable tapping effect due to the vibration direction. Certain other devices adopt a structure similar to that of fascia guns to achieve tapping through high-speed reciprocating impacts. However, such structures are typically bulky and generate strong impact forces, which may cause discomfort to delicate facial skin and are unsuitable for refined facial care.

It is an object of the present disclosure to overcome the deficiencies of the prior art and to provide a facial tapping apparatus driven by a voice coil motor, thereby solving the problem that existing facial massage devices produce tapping effects unsuitable for facial care.

To realize the above objective, the present disclosure provides a facial tapping apparatus driven by a voice coil motor, including: a housing; a tapping head arranged at a front end of the housing; a voice coil motor positioned within the housing and connected to the tapping head, wherein the voice coil motor is configured to drive the tapping head to reciprocate along a tapping direction relative to the housing; wherein a front end of the tapping head comprises a skin care contact portion, the skin care contact portion being configured for contacting human skin.

Furthermore, an elastic sealing component is arranged between the tapping head and the housing, the elastic sealing component being configured to allow the tapping head to reciprocate along the tapping direction while forming a seal inside the housing.

Furthermore, the elastic sealing component is an annular silicone component, an inner side of the elastic sealing component being connected to the tapping head and an outer side thereof being connected to the housing.

Furthermore, a circuit board is arranged inside the tapping head, the circuit board is provided with a light emitting component, and the skin care contact portion is provided with a light-transmitting portion, wherein the light emitting component is arranged corresponding to the light-transmitting portion.

Furthermore, the skin care contact portion comprises a conductive contact piece exposed externally, and the conductive contact piece is electrically connected to the circuit board via a conductive component.

Furthermore, the skin care contact portion further comprises an electrical muscle stimulation (EMS) electrode spaced from the conductive contact piece, the conductive contact piece and the EMS electrode being exposed on the skin care contact portion; wherein the facial tapping apparatus further comprises a microcurrent driving circuit electrically connected to the conductive contact piece and the EMS electrode to form an EMS microcurrent circuit when the conductive contact piece and the EMS electrode come into contact with the human skin.

Furthermore, the tapping head is provided with a heating component and a heat-conducting component, the heat-conducting component being thermally connected to the heating component and the conductive contact piece, respectively, so as to transfer heat generated by the heating component to the conductive contact piece.

Furthermore, the housing is provided with a metal middle frame for contact with a user's hand; wherein the facial tapping apparatus further comprises an ion-driving circuit respectively electrically connected to the conductive contact piece and the metal middle frame, so that when the conductive contact piece contacts facial skin and the metal middle frame contacts the skin of the user’s hand, an ion driving circuit is formed through the human body.

Furthermore, the skin care contact portion comprises an EMS electrode, the light-transmitting portion, and the conductive contact piece; the EMS electrode, the light-transmitting portion, and the conductive contact piece being arranged concentrically.

Furthermore, the EMS electrode is located in a center region of the skin care contact portion, the light-transmitting portion is arranged around the EMS electrode, and the conductive contact piece is arranged around the light-transmitting portion.

Furthermore, a first sealing ring is arranged between the EMS electrode and the light-transmitting portion, and a second sealing ring is arranged between the light-transmitting portion and the conductive contact piece.

Furthermore, a metal contact piece exposed externally is arranged at the front end of the housing, the metal contact piece being electrically connected to a touch detection circuit via an elastic conductive component, to output a touch detection signal when in contact with the human skin.

Furthermore, a control board is arranged inside the housing, the control board being configured to divide an internal space of the housing into a first space and a second space; the voice coil motor being arranged in the first space and a power supply component being arranged in the second space.

Furthermore, the front end of the housing is provided with a detachable fixing ring, the fixing ring being configured to secure a cotton sheet so that the cotton sheet covers the tapping head.

Furthermore, the fixing ring is connected to the housing via magnetic attraction.

Furthermore, the fixing ring is embedded with a magnet, and a metal ring attracting the magnet is arranged on the housing, the metal ring forming the metal contact piece.

Compared with the prior art, the technical solution of the present disclosure provides the following advantageous effects.

The facial tapping apparatus driven by a voice coil motor achieves a tapping effect suitable for facial care. Specifically, the apparatus employs a voice coil motor to drive the reciprocal movement of the tapping head, making the tapping motion more stable and gentle. Compared with conventional vibration motors or impact-type structures, the facial tapping apparatus is more suitable for facial skin care.

The structure is more compact. The voice coil motor enables linear drive, thereby simplifying the tapping mechanism and making the overall device structure more compact.

The reliability is higher. By providing an elastic sealing component between the tapping head and the housing, good sealing performance is maintained during the reciprocal movement of the tapping head, thereby enhancing the operational reliability of the facial tapping apparatus.

The functional integration is higher. Based on the tapping mechanism, additional functions such as phototherapy or electrical stimulation can be integrated at the skin care contact portion, allowing for a combination of multiple facial care functions.

Other features and advantages of the present disclosure will become apparent from the following description, in part from the description itself, and in part by implementing the present disclosure. The objectives and other advantages of the present disclosure can be realized and attained by the structures particularly pointed out in the specification and the accompanying drawings.

### BRIEF DESCRIPTION OF THE DRAWINGS

The present disclosure will be described in further detail below with reference to the accompanying drawings.

FIG. 1 is a schematic diagram of a facial tapping apparatus driven by a voice coil motor according to one embodiment of the present disclosure.

FIG. 2 is an exploded view of the facial tapping apparatus of FIG. 1.

FIG. 3 is a partial schematic view of the facial tapping apparatus driven by the voice coil motor.

FIG. 4 is a partial cross-sectional view of the facial tapping apparatus driven by the voice coil motor.

FIG. 5 is a block diagram of a microcurrent driving principle of a facial tapping apparatus driven by the voice coil motor.

FIG. 6 is an exploded view of a tapping head of the facial tapping apparatus.

FIG. 7 is a schematic diagram of the installation of a metal contact piece of the facial tapping apparatus.

FIG. 8 is schematic diagram of a contact detection principle of the facial tapping apparatus driven by the voice coil motor.

FIG. 9 is a front view of the facial tapping apparatus driven by the voice coil motor.

FIG. 10 is a block diagram of an ion driving principle of a facial tapping apparatus driven by the voice coil motor

FIG. 11 is a cross-sectional view of the facial tapping apparatus driven by the voice coil motor.

### DETAILED DESCRIPTION OF THE EMBODIMENTS

Embodiments of the present disclosure are described in detail below, and exemplary embodiments are illustrated in the accompanying drawings, wherein identical or similar reference numerals throughout the drawings indicate identical or similar components or components having identical or similar functions. The embodiments described below with reference to the accompanying drawings are exemplary and are intended to explain the present disclosure, and should not be construed as limiting the scope of the present disclosure.

In the description of the present disclosure, it should be understood that terms such as "length," "width," "upper," "lower," "front," "rear," "left," "right," "vertical," "horizontal," "top," "bottom," "inner," "outer," and the like, which indicate orientation or positional relationships, are based on the orientation or positional relationships shown in the accompanying drawings. They are provided merely for the convenience of describing the present disclosure and simplifying the description, and are not intended to indicate or imply that the apparatus or components must have a particular orientation, be constructed in a particular orientation, or operate in a particular orientation; therefore, they should not be construed as limiting the present disclosure.

Furthermore, the terms "first" and "second" are used solely for descriptive purposes and should not be understood as indicating or implying relative importance or implicitly specifying the number of the indicated technical features. Accordingly, features defined with "first" and "second" may explicitly or implicitly include one or more of such features. In the description of the present disclosure, the term "plurality" means two or more, unless otherwise explicitly specified.

In the embodiments of the present disclosure, unless otherwise explicitly stated and limited, the terms "mounted," "connected," "coupled," "fixed," and the like should be understood broadly; for example, they may indicate a fixed connection or a detachable connection, or an integral formation; they may indicate a mechanical connection or an electrical connection; they may indicate direct connection or indirect connection through an intermediate medium, and may represent communication within two components or interaction between two components. Those skilled in the art can understand the specific meaning of the above terms in the context of the present disclosure based on specific circumstances.

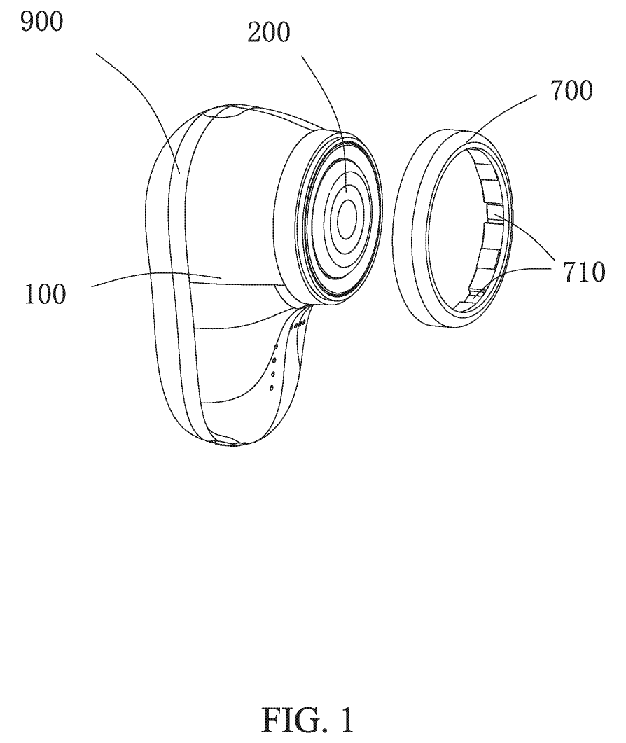

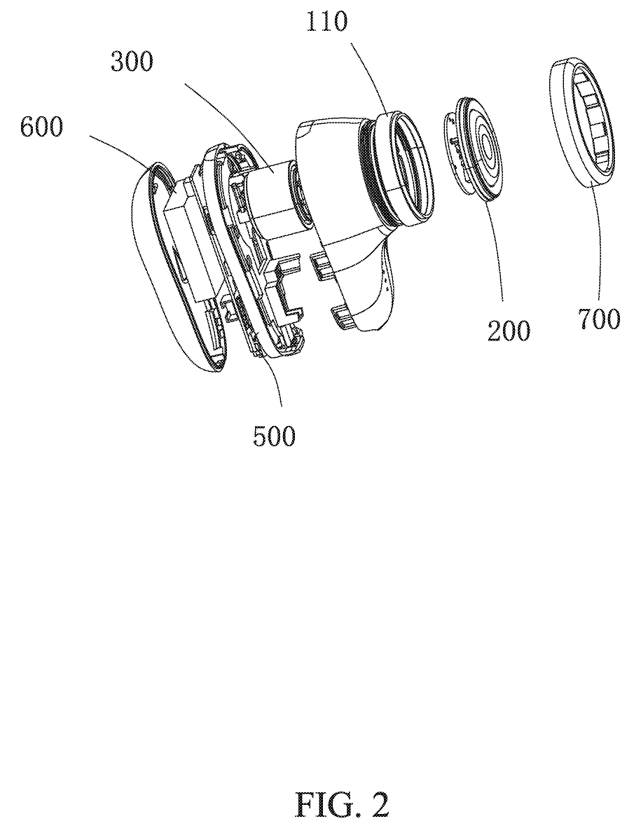

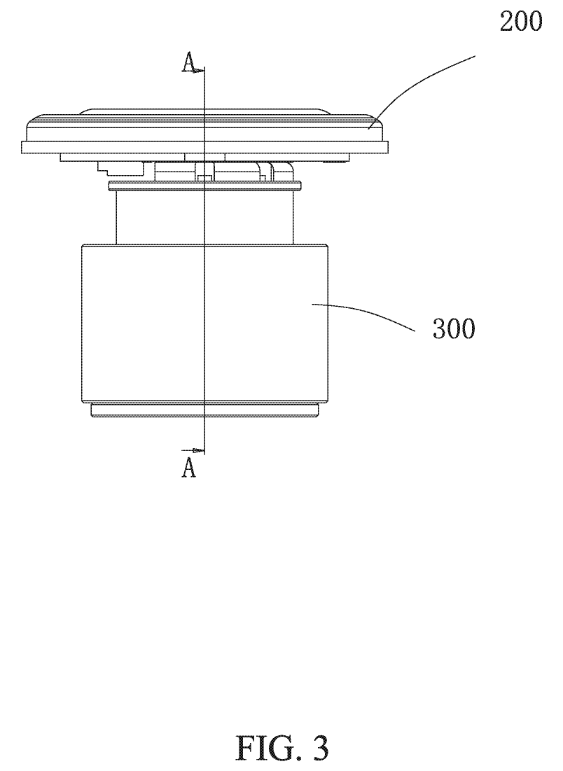

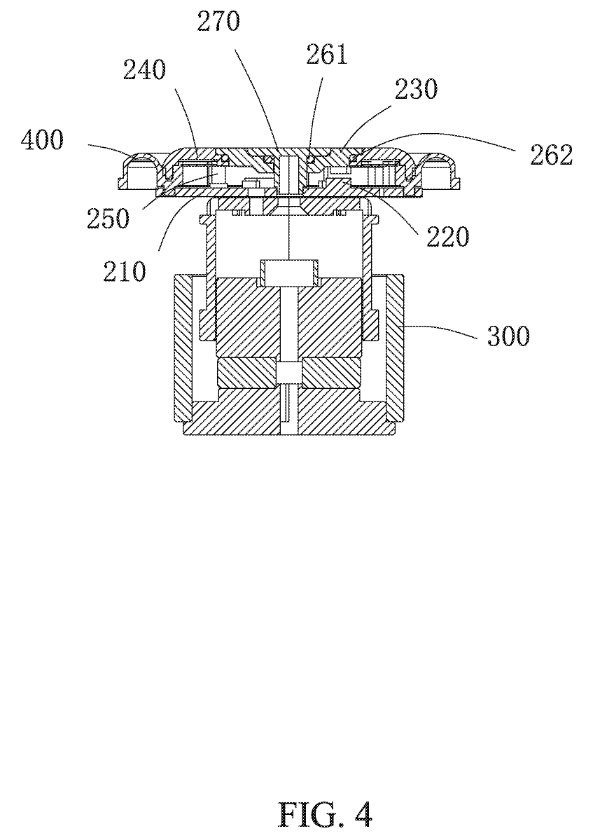

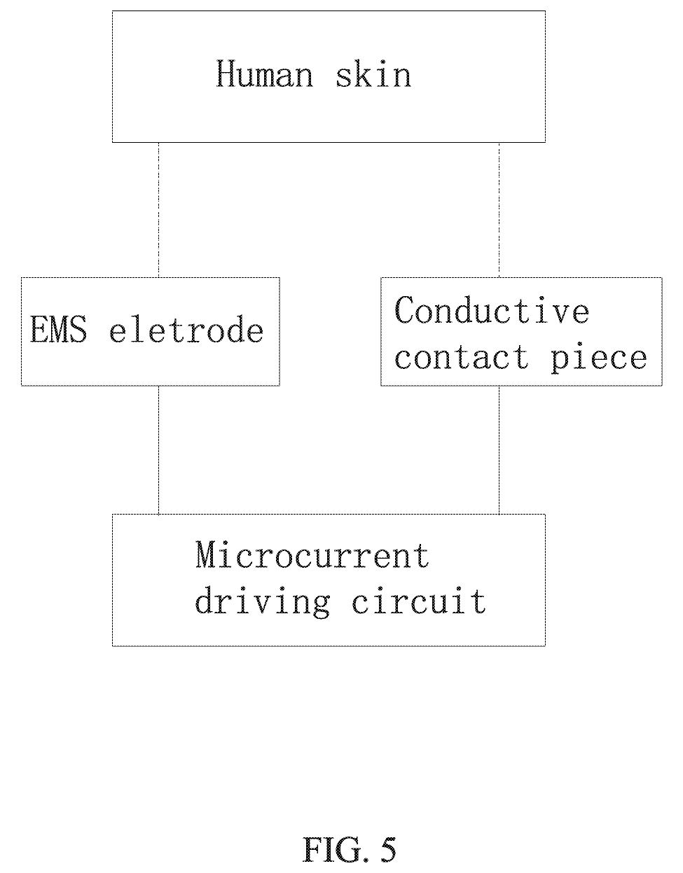

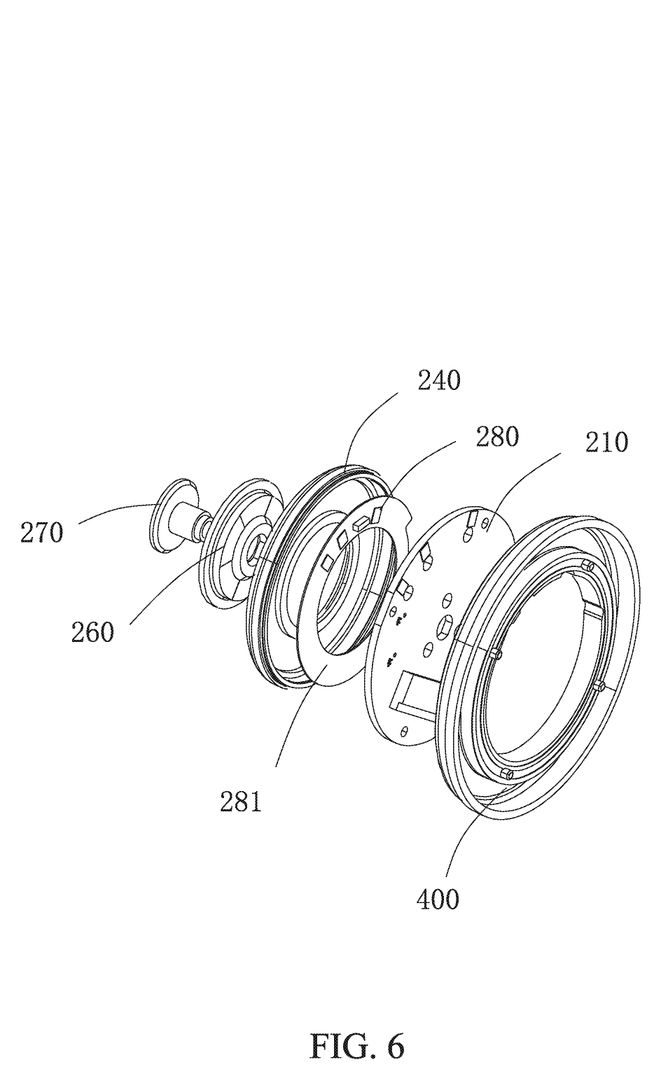

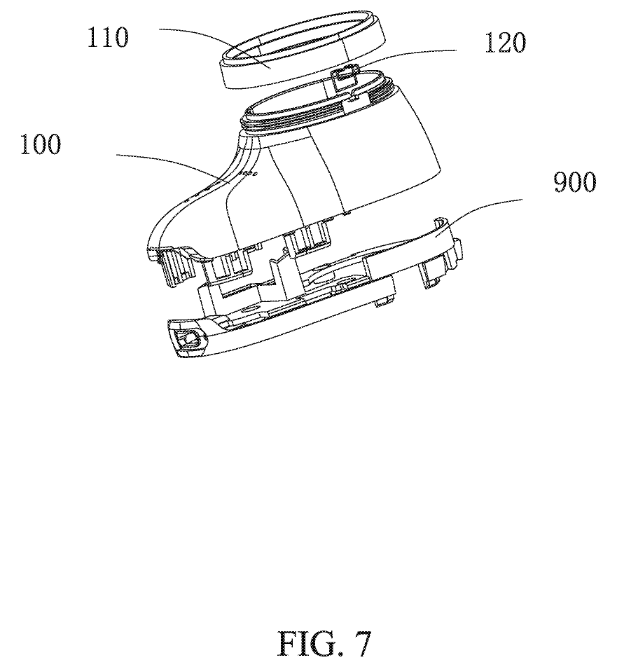

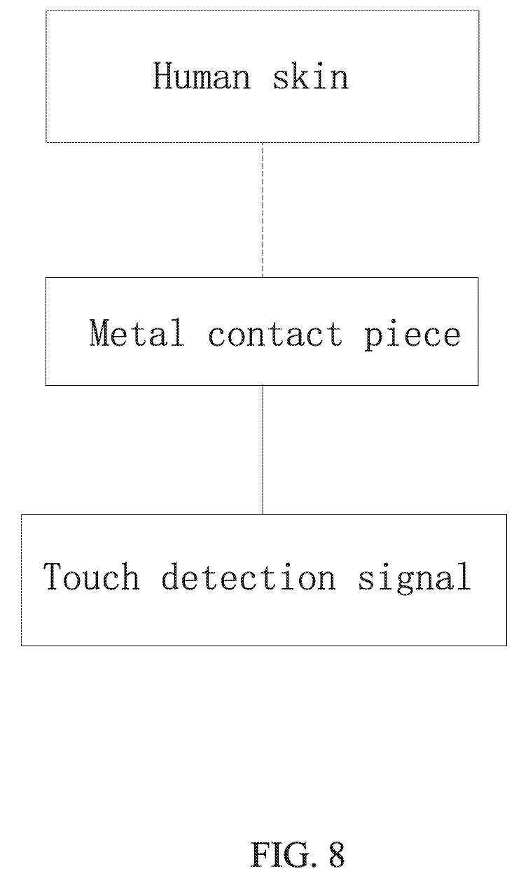

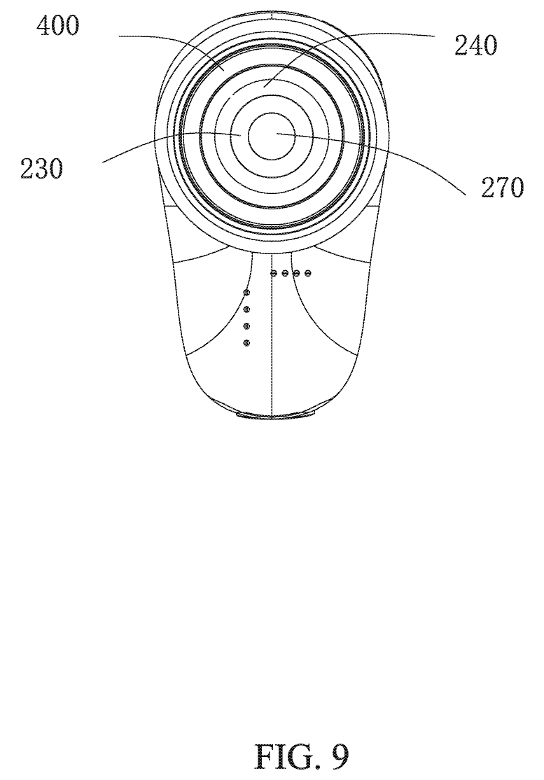

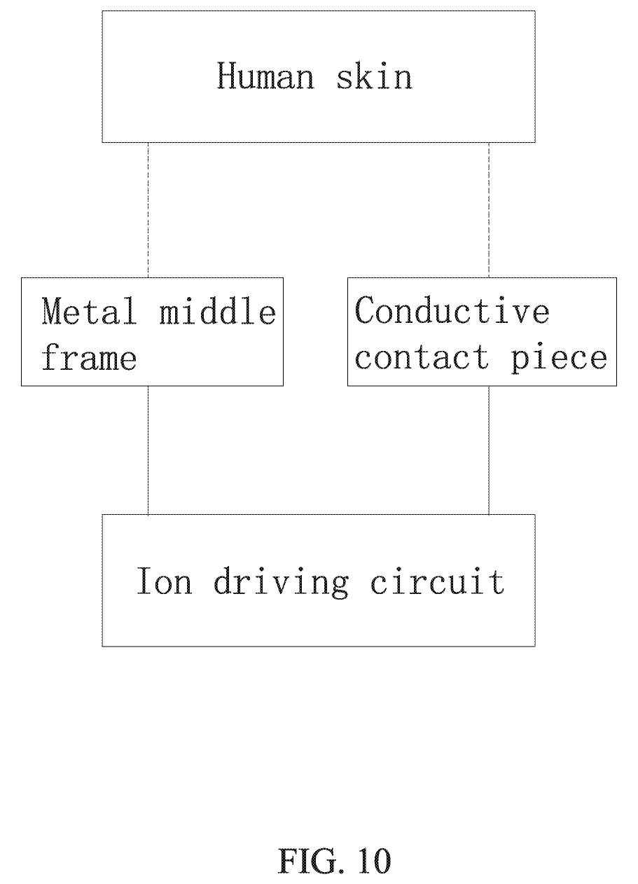

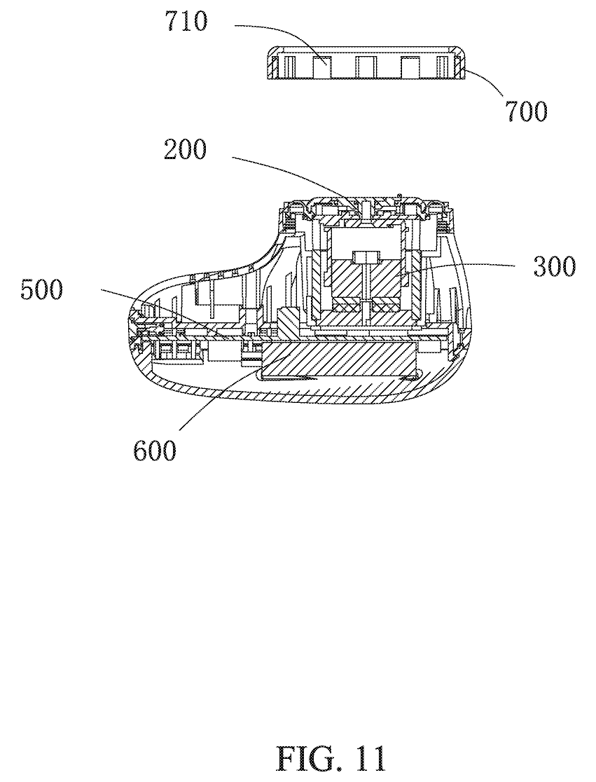

With reference to FIGS. 1-11, in the present embodiment, a facial tapping apparatus driven by a voice coil motor is provided. The facial tapping apparatus includes a housing 100, a tapping head 200, and a voice coil motor 300 disposed inside the housing 100. The tapping head 200 is disposed at a front end of the housing 100. The voice coil motor 300 is disposed inside the housing 100 and connected to the tapping head 200, for driving the tapping head 200 to reciprocate relative to the housing 100 along a tapping direction. The front end of the tapping head 200 forms the skin care contact portion, which is configured to contact human skin, thereby producing a tapping effect on the skin during movement of the tapping head 200.

In facial care applications, a user typically requires a tapping action with a certain rhythm to stimulate facial skin, to assist in the uniform distribution of skincare products on the skin surface or as a form of physical stimulation in daily care routines. However, some existing beauty devices primarily drive a massage head using a vibration motor to generate high-frequency vibrations, which usually have small amplitudes and cannot form a distinct tapping action. Other devices adopt a structure similar to a fascia gun, generating a tapping effect through a relatively long-stroke reciprocating impact. However, such structures generally produce relatively large impact forces and have a bulky overall size, which is unsuitable for use on sensitive areas such as the face. Accordingly, the facial care device industry has a long-standing need for a compact structural design capable of delivering stable, repeatable tapping motions.

Based on the above technical issues, the present embodiment provides the facial tapping apparatus driven by the voice coil motor. The design concept lies in utilizing the linear driving characteristic of the voice coil motor 300, allowing the tapping head 200 to directly reciprocate along the tapping direction, thereby forming a rhythmically stable tapping action. Specifically, the voice coil motor 300 is installed inside the housing 100 and connected to the tapping head 200. When the voice coil motor 300 is powered and operating, the electromagnetic driving force generated thereby drives the tapping head 200 to reciprocate along the tapping direction, such that the skin care contact portion at the front end of the tapping head 200 periodically contacts and leaves the skin surface, thereby forming a continuous tapping action.

During actual use, the user may lightly place the skin care contact portion on the surface of the facial skin. When the voice coil motor 300 drives the tapping head 200 to reciprocate, the skin care contact portion applies a tapping effect to the skin at a predetermined frequency. Since the voice coil motor 300 can achieve relatively stable reciprocating displacement control, the stroke and frequency of the tapping head 200 can be set according to design requirements, making the tapping action more suitable for facial care applications. Moreover, since the voice coil motor 300 can directly output linear motion, the associated structure does not require a complex mechanical conversion mechanism, allowing the overall facial tapping apparatus to remain relatively compact.

The facial tapping apparatus of the present embodiment can achieve a stable tapping action under relatively compact structural conditions, enabling the skin care contact portion to produce a rhythmical tapping effect when contacting the human skin, thereby being suitable for applications such as facial care.

An elastic sealing component 400 is arranged between the tapping head 200 and the housing 100. The elastic sealing component 400 allows the tapping head 200 to reciprocate along the tapping direction and forms a seal for the interior of the housing 100. In facial care applications, when using the facial tapping apparatus, the skin care contact portion typically directly contacts the human skin, often in combination with serums, lotions, or other care media. Therefore, the front end of the facial tapping apparatus may come into contact with certain liquids or moisture during operation. If there is a gap at the connection between the tapping head 200 and the housing 100, liquids or moisture may enter the interior of the housing 100 through the gap, thereby affecting the internal voice coil motor 300 and circuitry. Meanwhile, since the tapping head 200 needs to reciprocate relative to the housing 100 under the drive of the voice coil motor 300, a completely rigid sealing structure would easily restrict the movement of the tapping head 200, thereby affecting the realization of the tapping action.

To address the above technical issues, the present embodiment provides the elastic sealing component 400 between the tapping head 200 and the housing 100, which structurally possesses both elasticity and sealing capability. Specifically, the elastic sealing component 400 is connected between the tapping head 200 and the housing 100. When the tapping head 200 reciprocates along the tapping direction under the drive of the voice coil motor 300, the elastic sealing component 400 can adapt to the displacement of the tapping head 200 through its own elastic deformation, thereby allowing the tapping head 200 to reciprocate in the predetermined direction. At the same time, the elastic sealing component 400 surrounds the connection between the tapping head 200 and the housing 100, forming a continuous sealing structure, thereby reducing the possibility of external liquids or moisture entering the interior of the housing 100.

The tapping head 200 can perform normal reciprocating tapping movements while the interior of the housing 100 is protected by the seal, thereby improving the structural reliability of the facial tapping apparatus in facial care application scenarios.

In this embodiment, the elastic sealing component 400 is an annular silicone component, with its inner side connected to the tapping head 200 and its outer side connected to the housing 100. In the facial tapping apparatus of this embodiment, the tapping head 200 needs to move back and forth along the tapping direction, with the moving part located at the front of the facial tapping apparatus. During actual use, the tapping head 200 is easily exposed to water vapor, essence, or other care mediums on the skin's surface. Therefore, the connection area between the tapping head 200 and the housing 100 not only needs to allow displacement of the tapping head 200 but also requires a certain degree of sealing ability. Based on this, the present embodiment specifically sets the elastic sealing component 400 as an annular silicone component, connecting its inner side to the tapping head 200 and its outer side to the housing 100, thus forming an annular connection structure around the tapping head 200. Since silicone material itself has good elastic recovery ability and flexible deformation capacity, when the tapping head 200 moves back and forth in the tapping direction driven by the voice coil motor 300, the annular silicone component can adapt to the displacement of the tapping head 200 relative to the housing 100 through its own elastic deformation, without significantly hindering the normal tapping motion of the tapping head 200. At the same time, the annular silicone component is continuously arranged around the tapping head 200, forming a continuous annular sealing area between the tapping head 200 and the housing 100, thus reducing the likelihood of liquid, water vapor, or external impurities entering the interior of the housing 100 through this connection.

Compared to partial connections or discontinuous sealing structures, this embodiment, by setting the elastic sealing component 400 as an annular silicone component, with inner and outer sides respectively connected to the tapping head 200 and the housing 100, ensures both movement adaptability and sealing continuity in its structure. This design is more suitable for devices where the front-end tapping head 200 needs to perform repetitive back-and-forth movements and is applied in facial care scenarios, thus improving the sealing reliability and overall stability of the facial tapping apparatus during actual use.

In this embodiment, the tapping head 200 includes a circuit board 210, on which a light emitting component 220 is mounted. The skin care contact portion is equipped with a light-transmitting portion 230, and the light emitting component 220 is arranged corresponding to the light-transmitting portion 230. In facial care applications, some care devices not only apply mechanical stimulation to the skin but also combine light therapy to irradiate the skin, thus combining mechanical tapping and light therapy for skin care. Therefore, in this embodiment, the light emitting component 220 is set on the circuit board 210 inside the tapping head 200, and a light-transmitting portion 230 is provided in the skin care contact portion, allowing the light emitted by the light emitting component 220 to pass through the light-transmitting portion 230 and directly act on the care area.

Specifically, the light emitting component 220 can be a light-emitting diode (LED) bead used to emit light of a designated wavelength band when operating. Preferably, the light emitted by the light emitting component 220 is red light and/or blue light. The light-transmitting portion 230 is preferably a lens and is arranged on the skin care contact portion, with the lens aligned with the light emitting component 220, so that the red and/or blue light emitted by the light emitting component 220 can pass through the light-transmitting portion 230 and be directed outward to the human skin surface. In this embodiment, the light-transmitting portion 230 is mainly used to transmit the red and/or blue light emitted by the light emitting component 220, thus meeting the light therapy needs in facial care scenarios.

When the facial tapping apparatus operates, the voice coil motor 300 drives the tapping head 200 to reciprocate in the tapping direction, and the skin care contact portion periodically contacts and separates from the skin surface. Meanwhile, the red and/or blue light emitted by the light emitting component 220 passes through the corresponding lens in the light-transmitting portion 230 and irradiates the skin surface, enabling both tapping and light therapy to take place in the same care area simultaneously. By placing the light emitting component 220 inside the tapping head 200 and aligning it with the light-transmitting portion 230 on the skin care contact portion, it is possible to integrate the light therapy structure into the tapping head 200 without significantly increasing the overall size of the facial tapping apparatus, thus making the facial tapping apparatus structure more compact.

Additionally, because the light-transmitting portion 230 is arranged on the skin care contact portion, the light output area coincides with the skin contact area, ensuring that the light therapy area overlaps with the tapping area, which is advantageous for achieving synergistic effects of tapping and light therapy in facial care scenarios, thereby improving the care experience and ease of use.

Furthermore, the skin care contact portion includes a conductive contact piece 240 exposed externally, and the tapping head 200 is internally provided with the circuit board 210. The conductive contact piece 240 is electrically connected to the circuit board 210 via a conductive component. In facial care devices, some care functions require the conductive contact piece 240 on the skin care contact portion to form a conductive contact with the human skin, establishing a path for electric signal transmission between the skin care contact portion and the skin to enable microcurrent therapy, ion therapy, or other electrical care functions. However, in the facial tapping apparatus of this application, the tapping head 200, driven by the voice coil motor 300, needs to perform periodic back-and-forth movements in the tapping direction, and the skin care contact portion undergoes periodic displacement relative to the housing 100 as the tapping head 200 moves. If rigid wires or fixed connections are used between the conductive contact piece 240 and the internal circuit, the repeated movements of the tapping head 200 may cause issues such as force-induced connection instability, unstable contact, or structural interference, which would affect the stability and reliability of the facial tapping apparatus. To address this issue, this embodiment arranges the circuit board 210 inside the tapping head 200 and electrically connects the conductive contact piece 240 on the skin care contact portion to the circuit board 210 via a conductive component, thereby forming a conductive connection structure suitable for the motion state of the tapping head 200.

Specifically, the conductive contact piece 240 is exposed on the skin care contact portion. When the skin care contact portion contacts the skin, the conductive contact piece 240 is designed to form a conductive contact interface. The conductive component is positioned between the conductive contact piece 240 and the circuit board 210 to transmit electrical signals from the circuit board 210 to the conductive contact piece 240. Preferably, the conductive component may be an elastic conductive component, such as a conductive spring, conductive pin, or other elastic conductive structure, which adapts to the slight positional changes of the conductive contact piece 240 relative to the circuit board 210 during the tapping head's reciprocating motion and maintains a stable electrical connection between the conductive contact piece 240 and the circuit board 210. It is possible to achieve reliable conduction between the skin care contact portion and the internal circuit in the tapping head's movement, providing a structural foundation for integrating microcurrent therapy, ion therapy, or other electrical care functions. Additionally, the conductive component enables an adaptable connection between the conductive contact piece 240 and the circuit board 210, minimizing the impact of the tapping head's reciprocating motion on the stability of the electrical connection, thus improving the operational stability and reliability of the facial tapping apparatus in facial care applications.

Further, the skin care contact portion further includes an electrical muscle stimulation (EMS) electrode arranged at an interval from the conductive contact piece 240, wherein both the conductive contact piece 240 and the EMS electrode are exposed on the skin care contact portion, and the facial tapping apparatus further includes a microcurrent driving circuit electrically connected to the conductive contact piece 240 and the EMS electrode, so as to form an EMS microcurrent care loop when the conductive contact piece 240 and the EMS electrode are in contact with human skin. In facial care application scenarios, some care devices may contact human skin through two conductive contact regions arranged at an interval, so as to form a microcurrent transmission path therebetween, thereby achieving a microcurrent care effect on the skin or superficial muscle tissues. Based on this, in the present embodiment, the skin care contact portion is provided with a conductive contact piece 240 and an EMS electrode spaced apart from each other, and both are exposed on the skin care contact portion, so that both may simultaneously contact human skin when the facial tapping apparatus is operating. The microcurrent driving circuit is electrically connected to the conductive contact piece 240 and the EMS electrode, respectively. The microcurrent driving circuit is configured to output a microcurrent care signal to both of the conductive contact piece 240 and the EMS electrode. When the conductive contact piece 240 and the EMS electrode are jointly attached to human skin, the human skin may serve as a conductive medium therebetween, thereby forming an EMS microcurrent care loop between the conductive contact piece 240 and the EMS electrode, so as to realize a facial microcurrent care function. Since both the conductive contact piece 240 and the EMS electrode are disposed on the skin care contact portion and move synchronously with the tapping head 200, during the process in which the voice coil motor 300 drives the tapping head 200 to reciprocate along the tapping direction, the skin care contact portion can continuously generate a microcurrent care effect while periodically contacting and leaving the skin, thereby enabling the tapping care and the EMS care to be cooperatively performed in the same care region. By arranging the conductive contact piece 240 and the EMS electrode together on the skin care contact portion, on the one hand, an EMS care function can be integrated into the tapping head 200, thereby enriching the care modes of the facial tapping apparatus; and on the other hand, by utilizing the motion characteristics of the tapping head, mechanical tapping and microcurrent care can be output in a combined manner within the same care region, thereby improving the comprehensive care effect of the facial tapping apparatus in facial care scenarios.

Further, a heating component 280 and a heat-conducting component 261 are arranged in the tapping head 200, and the heat-conducting component 260 is in thermal connection with the heating component 280 and the conductive contact piece 240, respectively, so as to transfer heat generated by the heating component 280 to the conductive contact piece 240. In facial care devices, in order to improve care comfort and enrich care modes, it is generally necessary to provide a hot compress function at a portion in contact with the skin. However, the heating component 280 is generally arranged inside the facial tapping apparatus. If heat generated thereby cannot be effectively transferred to the skin care contact portion, heat utilization efficiency will be low, and even local heat concentration and uneven temperature rise in the contact region may be caused.

Accordingly, in the present embodiment, the heating component 280 and the heat-conducting component 261 are arranged in the tapping head, and the heat-conducting component 261 is in thermal connection with the heating component 280 and the conductive contact piece 240, respectively, thereby forming a heat transfer path from an internal heat source to the skin care contact portion. Specifically, the heating component 280 may be disposed on or in cooperation with the circuit board 210 inside the tapping head 200, and generates heat when energized. The heat-conducting component 261 is configured to absorb the heat generated by the heating component 280 and transfer the heat to the conductive contact piece 240 exposed on the skin care contact portion, so that the conductive contact piece 240 can output heat when in contact with human skin. Preferably, in addition to having a heat conduction function, the heat-conducting component 261 may also thermally diffuse, to a certain extent, a point-like heat source generated by the heating component 280, so that the heat is distributed more uniformly on the conductive contact piece 240, thereby improving the comfort of hot compressing. When the facial tapping apparatus is operating, the heating component 280 continuously generates heat, and the heat is transferred to the conductive contact piece 240 through the heat-conducting component 261. After the conductive contact piece 240 contacts the skin, hot compressing can be performed on the facial care region.

Through the above structural design, on the one hand, the structural characteristic of the conductive contact piece 240 as an exposed conductive contact piece 240 can be fully utilized, so that the hot compress function is integrated without significantly increasing additional conductive contact pieces. On the other hand, by establishing a heat conduction path between the heating component 280 and the conductive contact piece 240 through the heat-conducting component 261, heat transfer efficiency and temperature rise uniformity of the contact region can be improved, thereby improving use comfort and care experience of the facial tapping apparatus.

Further, the housing 100 is provided with a metal middle frame 900 for contact with a user's hand, and the facial tapping apparatus further includes an ion driving circuit electrically connected to the conductive contact piece 240 and the metal middle frame, respectively, so that, when the conductive contact piece 240 is in contact with facial skin and the metal middle frame is in contact with a user's skin, an ion care loop is formed through the human body. In some facial care scenarios, a care device may form an ion care loop through a conductive contact piece 240 disposed on a facial contact side and a conductive contact piece 240 disposed at a handheld portion, thereby realizing a corresponding ion care function. Based on this, in the present embodiment, the housing 100 is provided with the metal middle frame 900 for contact with the user's hand, and the metal middle frame 900 and the conductive contact piece 240 on the skin care contact portion are electrically connected to the ion driving circuit, respectively.

When the user holds the facial tapping apparatus, the skin of the hand contacts the metal middle frame 900. When the skin care contact portion is attached to facial skin, the conductive contact piece 240 contacts the facial skin. Accordingly, an ion care loop may be formed among the metal middle frame 900, the human body, and the conductive contact piece 240 under the action of the ion driving circuit. In this manner, the ion care function can be integrated with the tapping function in the same device, and can act cooperatively during facial care.

Further, since the conductive contact piece 240 is also disposed on the skin care contact portion, the conductive contact piece 240 can respectively perform conductive contact, heating contact, ion care contact, and the like under different operating modes, thereby improving the integration degree of the front-end care structure, reducing the number of repeatedly arranged functional members, and making the overall structure of the facial tapping apparatus more compact. By configuring the metal middle frame 900 as a conductive component for contact user’s hand, and enabling the metal middle frame 900 and the conductive contact piece 240 on the skin care contact portion to jointly constitute the ion care loop. On the one hand, integration of the ion care function can be achieved. On the other hand, the degree of functional reuse and the overall structural compactness of the facial tapping apparatus can also be improved, thereby making the facial tapping apparatus more suitable for application requirements of portable facial care devices.

Further, the skin care contact portion includes an EMS electrode, a light-transmitting portion, and a conductive contact piece 240. The EMS electrode, the light-transmitting portion, and the conductive contact piece 240 are concentrically arranged. In a facial care device, if a plurality of functional regions on the skin care contact portion are dispersedly arranged or have unreasonable positional relationships, it is likely to cause inconsistency among action regions of different care functions, thereby affecting the care experience and the overall structural compactness. Accordingly, in the present embodiment, the EMS electrode, the light-transmitting portion, and the conductive contact piece 240 are integrally arranged on the same skin care contact portion, and the three are concentrically arranged, so that different functional regions are laid out around the same care center. By means of such concentric arrangement, on the one hand, microcurrent care, light care, and conductive contact functions can be concentrated in the same care region, thereby avoiding mutual deviation among the action regions of different functions. On the other hand, integrated arrangement of multiple care structures can also be facilitated within the limited front end space of the tapping head, thereby improving the integration degree and the overall compactness of the front end care structure.

Further, the EMS electrode is located at the center of the skin care contact portion, with the light-transmitting portion surrounding the outer side of the EMS electrode and the conductive contact piece 240 surrounding the outer side of the light-transmitting portion. That is to say, in the radial direction of the skin care contact portion, the EMS electrode region, light-transmitting region, and conductive contact region are sequentially formed from the inside to the outside. The EMS electrode located at the center may preferentially form the central conductive contact region when the skin care contact portion contacts the skin, allowing it to cooperate with the external conductive contact piece 240 to form an EMS microcurrent care loop. The light-transmitting portion surrounding the EMS electrode on the outside may act as a light-transmitting area for the light emitted from the light-emitting component, allowing light to radiate outward around the center of the skin care contact portion. The conductive contact piece 240 surrounding the light-transmitting portion on the outside serves as the outer conductive contact region, used to form a conductive contact with the human skin and assume various functions, such as microcurrent care contact, heating contact, or ion care contact, depending on the working mode.

Through the aforementioned layered arrangement from inside to outside, the EMS electrode, light-transmitting portion, and conductive contact piece 240 can form clear spatial divisions, preventing the mixing of different functional areas. When the skin care contact portion contacts the human skin, various care functions such as tapping, lighting, microcurrent, and conductive contact can be simultaneously achieved around the same central region, thereby improving the consistency of the care area and enhancing the overall care effect.

Further, a first sealing ring 261 is provided between the EMS electrode and the light-transmitting portion, and a second sealing ring 262 is provided between the light-transmitting portion and the conductive contact piece 240. When integrating the EMS electrode, light-transmitting portion, and conductive contact piece 240 in the skin care contact portion, a lack of effective isolation between adjacent functional regions may not only affect the assembly stability but also potentially lead to issues such as liquid infiltration, structural loosening, or interference between different functional areas during use. Based on this, the present embodiment sets a first sealing ring 261 between the EMS electrode and the light-transmitting portion and a second sealing ring 262 between the light-transmitting portion and the conductive contact piece 240, forming a double-sealing isolation structure between adjacent functional regions.

Specifically, the first sealing ring 261 is arranged around the EMS electrode and the light-transmitting portion, sealing the central electrode region and the middle light-transmitting region. The second sealing ring 262 is arranged around the light-transmitting portion and the conductive contact piece 240, sealing the middle light-transmitting region and the outer conductive contact region. By setting the first and second sealing rings, stable separation of the multi-layer concentric structure of the skin care contact portion is achieved, improving the assembly reliability of each functional area. The first and second sealing rings also help reduce the risk of external liquids, moisture, or care liquids infiltrating the interior of the tapping head, thereby improving the sealing performance and reliability of the facial tapping apparatus in facial care scenarios. At the same time, the double-sealing ring structure can also improve the boundary stability between functional areas to some extent, keeping the relative position of the EMS electrode, light-transmitting portion, and conductive contact piece 240 stable during long-term use, which is beneficial for maintaining the overall structural integrity and functional stability of the skin care contact portion.

Further, the front end of the housing 100 is provided with a metal contact piece 110 exposed externally, which is electrically connected to the touch detection circuit via an elastic conductive component and is used to output a touch detection signal when in contact with human skin. In facial care devices, if the tapping function remains continuously active, the tapping head will keep reciprocating even when the facial tapping apparatus does not actually contact human skin, which not only causes ineffective work and increases energy consumption but may also affect the safety of use when accidentally touching other objects. Based on this, the present embodiment sets the exposed metal contact piece 110 at the front end of the housing 100 and electrically connects it to the touch detection circuit through an elastic conductive component, forming a touch detection structure for detecting the human skin contact state.

Specifically, the exposed metal contact piece 110 is arranged at the front end of the housing 100 and forms a contact interface with the human skin when the facial tapping apparatus is close to or in contact with the skin. The elastic conductive component is arranged between the metal contact piece 110 and the touch detection circuit, transmitting the touch signal detected by the metal contact piece 110 to the touch detection circuit. Preferably, the elastic conductive component may be a conductive spring, conductive pin, or any other conductive structure with elastic conductive capabilities, ensuring stable electrical continuity between the metal contact piece 110 and the internal circuit in the facial tapping apparatus assembly state, and adapting to assembly errors or small displacement changes at the front end of the housing 100, thereby improving the stability of touch signal transmission.

When the user applies the facial tapping apparatus to the facial care area, the human skin contacts the metal contact piece 110, which then transmits the touch signal through the elastic conductive component to the touch detection circuit. The touch detection circuit outputs the corresponding touch detection signal, allowing the control system to determine whether the facial tapping apparatus is in an effective skin-contacting state.

Furthermore, in some embodiments, the touch detection signal can be used to trigger the start or stop of the voice coil motor 300, i.e., when the touch detection circuit detects human skin contact, the control system drives the voice coil motor 300 to perform tapping operations. When no skin contact is detected, the voice coil motor 300 stops working. The facial tapping apparatus can control the tapping function based on the actual skin contact state, reducing unnecessary operation and energy consumption. It also helps reduce the risk of continuous tapping when the facial tapping apparatus mistakenly contacts non-target objects, improving the safety and intelligence of the facial care device.

In this embodiment, the housing 100 is provided with a control board 500, which divides the internal space of the housing 100 into a first space and a second space, with the voice coil motor 300 arranged in the first space and the power supply component 600 arranged in the second space. In the facial tapping apparatus of this application, in order to enable the voice coil motor 300 to drive the tapping head 200 to reciprocate along the tapping direction, the internal space of the housing 100 generally needs to accommodate the voice coil motor 300, the power supply component 600, and associated circuit structures.

Due to the relatively small overall size of the facial tapping apparatus, and the need to arrange both the driving area corresponding to the tapping head 200 at the front end and the power supply area at the back or bottom within the same housing 100, if the functional components are randomly stacked inside the housing 100, it will result in low space utilization, complex assembly relationships, and inefficient area layout. Based on this, the present embodiment sets the control board 500 inside the housing 100, dividing the internal space of the housing 100 into a first space and a second space. The first space is used to arrange the voice coil motor 300, and the second space is used to arrange the power supply component 600. Specifically, the control board 500 may be arranged transversely or spaced within the housing 100, dividing the internal space into two relatively independent regions with either vertical or horizontal distribution. The voice coil motor 300 is placed in the first space close to the tapping head 200 to form a more direct connection with the front-end tapping head 200. The power supply component 600 is placed in the second space to supply power to the voice coil motor 300 and other electrical components.

Through this structural design, on the one hand, a relatively clear partition layout of the voice coil motor 300 and power supply component 600 inside the housing 100 is achieved, improving space utilization and making the overall structure more compact. On the other hand, the voice coil motor 300 is arranged in the first space near the tapping head 200, which also helps shorten the connection path between the voice coil motor 300 and the tapping head 200, thereby concentrating the tapping drive structure and facilitating the miniaturization of the front-end tapping structure.

In the present embodiment, a detachable fixing ring 700 is provided at the front end of the housing 100. The fixing ring 700 is configured to secure a soft cotton sheet, so that the cotton sheet covers the tapping head 200. In facial care applications, when a user operates the facial tapping apparatus, it is typically used in combination with essence, toner, or other care liquids. If the skin care contact portion directly contacts the skin and the care liquids, residues of the liquids may remain on the surface of the tapping head 200, which not only increases the difficulty of subsequent cleaning but may also affect the hygienic condition of the facial tapping apparatus during repeated use. Based on this, in the present embodiment, the detachable fixing ring 700 is arranged at the front end of the housing 100, and the cotton sheet is secured by the fixing ring 700, allowing the cotton sheet to cover the tapping head 200. Accordingly, a replaceable intermediary layer is formed between the tapping head 200 and the skin. Specifically, the cotton sheet may pre-absorb a certain amount of essence or care liquid. When the fixing ring 700 is installed on the front end of the housing 100, the cotton sheet can be secured between the fixing ring 700 and the tapping head 200, thereby covering the skin care contact portion of the tapping head 200.

When the facial tapping apparatus operates, the voice coil motor 300 drives the tapping head 200 to reciprocate along the striking direction. The tapping head 200 exerts a tapping effect on the skin surface through the cotton sheet, while the care liquid absorbed in the cotton sheet contacts the skin during the tapping process. By providing the detachable fixing ring 700, the cotton sheet can maintain a stable position during tapping without easily slipping or detaching. Since the cotton sheet is a replaceable component, the user can replace it after use, thereby helping maintain the cleanliness and hygienic condition of the facial tapping apparatus during facial care applications.

In the present embodiment, the fixing ring 700 is connected to the housing 100 via magnetic attraction. In actual use of a facial care device, the fixing ring 700 needs to be installed when mounting the cotton sheet and easily removed when the cotton sheet is not used. If the fixing ring 700 adopts mechanical connection means such as a threaded connection or snap-fit connection, a relatively large operating force may be required for assembly and disassembly, and the structure is relatively complex, which is not conducive to quick replacement by the user during daily use. Based on this, a magnetic attraction structure is arranged between the fixing ring 700 and the housing 100, so that the fixing ring 700 can be connected to the housing 100 via magnetic attraction. Specifically, when the fixing ring 700 approaches the front end of the housing 100, the magnetic attraction structure causes the fixing ring 700 to automatically attach and position at the front end of the housing 100 under magnetic force, thereby completing the installation of the fixing ring 700. When it is necessary to replace the cotton sheet or when the fixing ring 700 is not used, the user can directly remove the fixing ring 700 from the housing 100, thereby realizing quick disassembly of the fixing ring 700. Through the above structural design, on one hand, the connection between the fixing ring 700 and the housing 100 is simplified, making installation and removal more convenient. On the other hand, the magnetic attraction connection does not require a complex locking structure, which helps reduce the structural complexity at the front end of the housing 100 and improves the overall simplicity and usability of the facial tapping apparatus.

Further, the fixing ring 700 internally embeds a magnet 710, and a metal ring is arranged on the housing 100 to be attracted by the magnet 710, the metal ring constitutes the exposed metal contact piece 110 described above. In a facial care device, the fixing ring 700 is typically used to secure auxiliary care media such as a cotton sheet. If the fixing ring 700 and the housing 100 adopt a snap-fit, threaded, or other mechanical connection, the disassembly operation is cumbersome and may increase the complexity of the front-end structure, which is not conducive to improving operational convenience. Based on this, the magnet 710 is embedded in the fixing ring 700, and a metal ring is arranged on the housing 100 to be attracted by the magnet 710, so that the fixing ring 700 can be quickly and detachably installed at the front end of the housing 100 through magnetic attraction.

Specifically, the magnet 710 may be embedded inside the fixing ring 700 and arranged along the circumferential or partial region of the fixing ring 700. The metal ring is disposed at a corresponding position on the front end of the housing 100 to cooperate with the magnet 710 to generate magnetic attraction. When the fixing ring 700 approaches the front end of the housing 100, the magnet 710 and the metal ring attract each other, thereby reliably attaching the fixing ring 700 to the housing 100. When it is necessary to replace the cotton sheet or remove the fixing ring 700, the user can directly remove the fixing ring 700 from the housing 100, facilitating convenient and quick operation. Through this structural design, on one hand, the installation and disassembly of the fixing ring 700 is simplified, improving the convenience of cotton sheet replacement. On the other hand, it reduces the need for complex mechanical connection structures, making the front-end structure more compact and concise.

Further, in the present embodiment, the metal ring not only serves as a magnetic attraction component that cooperates with the magnet 710 but also functions as the metal contact piece 110 for touch detection. Specifically, while fulfilling the magnetic connection function of the fixing ring 700, the metal ring can also electrically connect to a touch detection circuit via an elastic conductive component, thereby outputting a touch detection signal upon contact with human skin. Accordingly, the metal ring achieves functional multiplexing, serving simultaneously as both a magnetic coupling member and a touch detection member. This allows the same component to perform both the installation and fixation of the fixing ring 700 and skin-contact detection. By configuring the metal ring as a composite structure that integrates magnetic attraction and touch detection functions, the number of functional components at the front end is reduced, thereby improving structural integration. At the same time, space occupation at the front end is minimized, resulting in a more compact overall structure and further enhancing assembly convenience and operational reliability in facial care applications.

In summary, the present embodiment provides a facial tapping apparatus driven by the voice coil motor 300. By disposing the voice coil motor 300 inside the housing 100 and directly driving the tapping head to reciprocate along the striking direction, the tapping head can perform stable tapping motions. This achieves a tapping structure suitable for facial care applications while maintaining a relatively compact structure. Compared with conventional facial care devices that commonly employ vibration motor-driven mechanisms or rely on complex mechanical transmission structures to achieve tapping effects, the present embodiment utilizes the linear drive characteristics of the voice coil motor 300 to directly drive the tapping head. This simplifies the drive mechanism, enables more stable and precisely controllable tapping actions, and makes the apparatus more suitable for miniaturized facial care devices.

On this basis, the present embodiment further includes an elastic sealing component 400 disposed between the tapping head and the housing 100. This component accommodates the reciprocating movement of the tapping head while maintaining the internal sealing of the housing 100. In addition, the EMS electrode, light-transmitting portions, and conductive contacts are integrated on the skin care contact portion in a concentric layered arrangement from the inside out. This configuration enables microcurrent care, light therapy, conductive contact, and heating care to synergistically act on the same care region. Furthermore, an exposed metal contact is provided at the front end of the housing 100 and is electrically connected to the touch detection circuit, enabling the facial tapping apparatus to output a touch detection signal upon skin contact and thereby realizing contact-detection control of the tapping function. Moreover, a detachable fixing ring 700 is provided that utilizes the magnet 710 embedded in the fixing ring 700 together with the metal ring on the housing 100 to conveniently secure the cotton sheet. At the same time, the metal ring also functions as the 110, thereby achieving functional multiplexing of magnetic connection and touch detection.

Therefore, the present embodiment not only differs from the prior art in the tapping drive mode but also constitutes an integrated technical solution that encompasses the structural layout of the front-end skin care contact portion, the integration of multiple care functions, and the multiplexing of auxiliary fixing and detection structures. Through the above structural design, multiple functions—including tapping, light therapy, microcurrent care, heating, ion therapy, and touch detection—can be integrated while ensuring a compact overall structure. This better meets the application requirements of facial care devices and offers significant technical value and broad practical application prospects.

Finally, it should be noted that the foregoing is merely a preferred embodiment of the present disclosure and is not intended to limit the present disclosure. Although the present disclosure has been described in detail with reference to the foregoing embodiments, those skilled in the art may still modify the technical solutions described in the foregoing embodiments or make equivalent substitutions for some of the technical features. Any modifications, equivalent substitutions, improvements, or the like made within the spirit and principle of the present disclosure shall fall within the scope of the present disclosure.

What is claimed is:

1. A facial tapping apparatus driven by a voice coil motor, comprising:
a housing;
a tapping head arranged at a front end of the housing;
a voice coil motor positioned within the housing and connected to the tapping head, wherein the voice coil motor is configured to drive the tapping head to reciprocate along a tapping direction relative to the housing;
wherein a front end of the tapping head comprises a skin care contact portion, the skin care contact portion being configured for contacting human skin.

2. The facial tapping apparatus according to claim 1, wherein an elastic sealing component is arranged between the tapping head and the housing, the elastic sealing component being configured to allow the tapping head to reciprocate along the tapping direction while forming a seal inside the housing.

3. The facial tapping apparatus according to claim 2, wherein the elastic sealing component is an annular silicone component, an inner side of the elastic sealing component being connected to the tapping head and an outer side thereof being connected to the housing.

4. The facial tapping apparatus according to claim 1, wherein a circuit board is arranged inside the tapping head, the circuit board is provided with a light emitting component, and the skin care contact portion is provided with a light-transmitting portion, wherein the light emitting component is arranged corresponding to the light-transmitting portion.

5. The facial tapping apparatus according to claim 4, wherein the skin care contact portion comprises a conductive contact piece exposed externally, and the conductive contact piece is electrically connected to the circuit board via a conductive component.

6. The facial tapping apparatus according to claim 5, wherein the skin care contact portion further comprises an electrical muscle stimulation (EMS) electrode spaced from the conductive contact piece, the conductive contact piece and the EMS electrode being exposed on the skin care contact portion;
wherein the facial tapping apparatus further comprises a microcurrent driving circuit electrically connected to the conductive contact piece and the EMS electrode to form an EMS microcurrent circuit when the conductive contact piece and the EMS electrode come into contact with the human skin.

7. The facial tapping apparatus according to claim 5, wherein the tapping head is provided with a heating component and a heat-conducting component, the heat-conducting component being thermally connected to the heating component and the conductive contact piece, respectively, so as to transfer heat generated by the heating component to the conductive contact piece.

8. The facial tapping apparatus according to claim 5, wherein the housing is provided with a metal middle frame for contact with a user's hand;
wherein the facial tapping apparatus further comprises an ion-driving circuit respectively electrically connected to the conductive contact piece and the metal middle frame, so that when the conductive contact piece contacts facial skin and the metal middle frame contacts the skin of the user’s hand, an ion driving circuit is formed through the human body.

9. The facial tapping apparatus according to claim 5, wherein the skin care contact portion comprises an EMS electrode, the light-transmitting portion, and the conductive contact piece; the EMS electrode, the light-transmitting portion, and the conductive contact piece being arranged concentrically.

10. The facial tapping apparatus according to claim 9, wherein the EMS electrode is located in a center region of the skin care contact portion, the light-transmitting portion is arranged around the EMS electrode, and the conductive contact piece is arranged around the light-transmitting portion.

11. The facial tapping apparatus according to claim 10, wherein a first sealing ring is arranged between the EMS electrode and the light-transmitting portion, and a second sealing ring is arranged between the light-transmitting portion and the conductive contact piece.

12. The facial tapping apparatus according to claim 1, wherein a metal contact piece exposed externally is arranged at the front end of the housing, the metal contact piece being electrically connected to a touch detection circuit via an elastic conductive component, to output a touch detection signal when in contact with the human skin.

13. The facial tapping apparatus according to claim 1, wherein a control board is arranged inside the housing, the control board being configured to divide an internal space of the housing into a first space and a second space; the voice coil motor being arranged in the first space and a power supply component being arranged in the second space.

14. The facial tapping apparatus according to claim 12, wherein the front end of the housing is provided with a detachable fixing ring, the fixing ring being configured to secure a cotton sheet so that the cotton sheet covers the tapping head.

15. The facial tapping apparatus according to claim 14, wherein the fixing ring is connected to the housing via magnetic attraction.

16. The facial tapping apparatus according to claim 15, wherein the fixing ring is embedded with a magnet, and a metal ring attracting the magnet is arranged on the housing, the metal ring forming the metal contact piece.
